(19) United States
(12) Patent Application Publication
(10) Pub. No.: US 2025/0306939 A1
(43) Pub. Date: Oct. 2, 2025

(54) APPARATUSES, SYSTEMS, AND METHODS FOR OUT-OF-ORDER TASK RESOLUTION IN INTEGRATED CIRCUITS

(71) Applicant: Advanced Micro Devices, Inc., Santa Clara, CA (US)

(72) Inventors: Erik Swanson, Fort Collins, CO (US); Michael Estlick, Fort Collins, CO (US); Eric Dixon, Fort Collins, CO (US)

(73) Assignee: Advanced Micro Devices, Inc., Santa Clara, CA (US)

(21) Appl. No.: 18/620,948

(22) Filed: Mar. 28, 2024

(51) Int. Cl. G06F 9/38; G06F 9/30; G06F 9/48

(52) U.S. Cl. CPC G06F 9/3838; G06F 9/30043; G06F 9/485

(57) ABSTRACT

An integrated circuit that performs computations according to an out-of-order execution scheduling scheme can include a first computing region and a second computing region. Such an integrated circuit can also include (i) a first retirement register that stores results of computations performed by the first computing region, and (ii) a second retirement register, physically disposed in proximity to the second computing region, that stores results of computations performed by the second computing region. Various other apparatuses, systems, and methods are also disclosed.

### BACKGROUND

Many integrated circuits use out-of-order execution (OoOE) schemes (also referred to as dynamic execution schemes) to improve efficiency and increase the number of operations that can be performed in a given amount of time. As part of ensuring that operations are handled correctly, integrated circuits that use such schemes maintain a retirement queue or other record of “in-flight” operations, or operations that have been completed but not yet written back to a value register. The retirement queue ensures that the original program order of instructions provided to the integrated circuit appears to remain consistent to other components of a computing system despite the actual execution order of the instructions being out of order. Some examples of integrated circuits that use OoOE schemes include central processing units (CPUs).

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an example system for out-of-order task resolution in integrated circuits.

FIG. 2 is a block diagram of an additional example system for out-of-order task resolution in integrated circuits.

FIG. 3 is a block diagram of an example system for out-of-order task resolution in integrated circuits.

FIG. 4 is a block diagram showing how portions of an example system for out-of-order task resolution in integrated circuits map to each other.

FIG. 5 is a flow diagram of an example method for out-of-order task resolution in integrated circuits.

FIG. 6 is a block diagram of an example system for out-of-order task resolution in integrated circuits.

Throughout the drawings, identical reference characters and descriptions indicate similar, but not necessarily identical, elements. While the examples described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure is generally directed to out-of-order task resolution in integrated circuits. Integrated circuits that use out-of-order execution (OoOE) schemes need some way of reconciling tasks performed out of order during a timeframe with the original program order of instructions issued to the integrated circuit. Many integrated circuits use retirement queues to track tasks that are “in flight”, i.e., have been calculated and completed but are being held for final resolution so that other devices and/or systems outside the integrated circuit are presented with the illusion that tasks were completed in order. However, there is significant room for improvement in OoOE task handling.

As will be described in greater detail below, the efficiency of retirement queueing systems can be improved by the incorporation of dedicated physical registers that store entries related to a single data type and are likewise physically situated near the physical logic units that perform the related calculations. These additional data-type specific retirement queues can improve the electrical and thermal efficiency of an integrated circuit by minimizing the distance signals need to travel between the register and the associated logic unit, along with increased electrical efficiency when performing retire operations. Similarly, having registers that only store entries related to a single data type can allow these registers to perform faster flush recovery than registers that store entries related to many different data types. Moreover, each register can perform a certain number of tasks per clock cycle. Therefore, maintaining additional registers can speed up flush recovery of the retirement system of an integrated circuit by enabling the integrated circuit to perform more actions per cycle. The examples described herein are primarily directed to additional registers for tracking floating point operations (i.e., operations performed by a floating point logic unit), although additional retirement registers could be incorporated for any appropriate data type or logic unit in an integrated circuit.

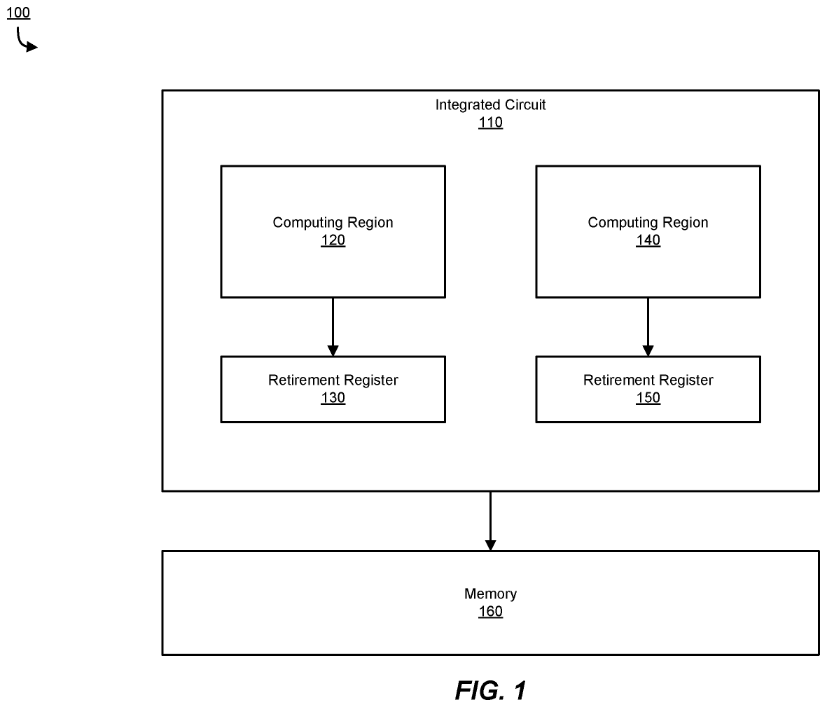

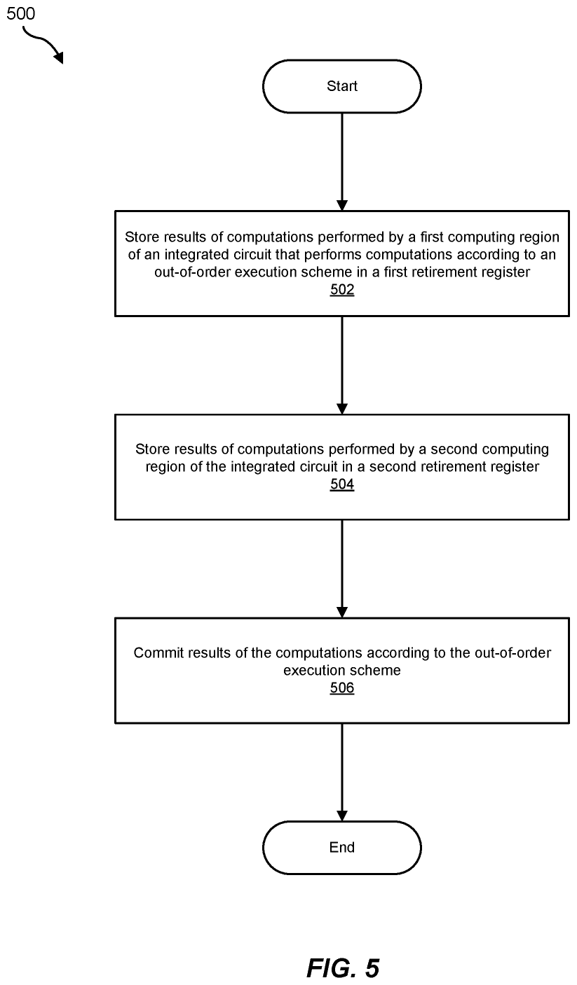

The following will provide, with reference to FIGS. 1-4, detailed descriptions of example systems for out-of-order task resolution in integrated circuits Detailed descriptions of corresponding computer-implemented methods will also be provided in connection with FIG. 5.

An integrated circuit that utilizes an out-of-order task scheduling scheme can include a first computing region and a second computing region. The integrated circuit can also include a first retirement register that stores a first set of entries that pertain to results of computations performed by the first computing region and a second retirement register, physically disposed in proximity to the second computing region, that stores a second set of entries that pertain to results of computations performed by the second computing region. In some examples, the second computing region can include a floating point logic unit. In these examples, the second retirement register stores entries that pertain to results of computations performed by the floating point logic unit.

In some embodiments, the second retirement register can include mappings back to the first retirement register. In these embodiments, the second retirement register stores each entry in the second set of entries in association with a retirement identifier that maps the result to a position in a global retirement queue. This global retirement queue specifies a retirement order for results of computations performed by both the first and second computing regions. In some embodiments, the first set of entries may include the information necessary to properly retire calculations performed by both the first and second computing regions.

In some examples, one or more of the retirement registers can be physically disposed within their associated computing regions. For example, the second retirement register can be physically disposed within the second computing region.

A system for managing out-of-order task resolution can include the integrated circuit as described above, namely an integrated circuit that performs computations according to an out-of-order execution scheduling scheme and includes a first and second computing region. The integrated circuit can also include a first retirement register that stores a first set of entries pertaining to results of computations performed by the first computing region and a second retirement register that stores a second set of entries pertaining to results of computations performed by the second computing region. The system can also include a physical memory that stores an output of the integrated circuit.

A method for managing out-of-order task resolution can include (i) storing a first set of entries pertaining to results of computations performed by a first computing region of an integrated circuit in a first retirement register, wherein the integrated circuit performs computations according to an out-of-order execution scheduling scheme; (ii) storing a second set of entries pertaining to results of computations performed by a second computing region of the integrated circuit in a second retirement register that is physically disposed in proximity to the second computing region; and (iii) committing, based on the first set of entries and the second set of entries, results of the computations performed by the first and second computing regions from the first and second retirement registers according to the out-of-order execution scheduling scheme.

In some embodiments, one of the retirement registers can store pointers to data stored in a different retirement register. For example, the first retirement register described above can store pointers to results stored in the second retirement register.

In some examples, the integrated circuit can include a retirement logic management component that ensures results of computations performed by the first computing region and the second computing region are processed according to the out-of-order execution scheduling scheme and properly reflect the program order of instructions handled by the integrated circuit. In some embodiments, the integrated circuit comprises a central processing unit (CPU).

FIG. 1 is a block diagram of an example system for out-of-order task resolution in integrated circuits. As illustrated in this figure, an example integrated circuit 110 can include two or more computing regions, illustrated here as computing region 120 and computing region 140. Each retirement register can include entries that contain information pertaining to results of calculations performed by their associated computing regions. In the example of FIG. 1, computing region 120 outputs results of calculations that are tracked by retirement register 130, and computing region 140 outputs results of calculations that are tracked by retirement register 150. The integrated circuit can use other computing regions, modules, or components to output data to memory 160, which can be memory that is incorporated into integrated circuit 110, external to integrated circuit 110, or a combination of the two.

Although the example of FIG. 1 shows each computing region as being associated with a single respective retirement register, a single retirement register can in some embodiments serve more than one computing region depending on the configuration of the integrated circuit. For example, retirement register 130 may be configured as a general or global retirement register, and retirement register 150 may be configured as a floating point operations retirement register. In this example, if computing region 120 performs a floating point operation, the result of that operation may be tracked by retirement register 150 as opposed to retirement register 130. Additionally or alternatively, a third computing region (not illustrated in FIG. 1) can perform operations that are tracked by either retirement register 130 or retirement register 150. Likewise, in some embodiments, a single computing region can have results tracked by more than one retirement register. For example, a single computing region can perform integer math operations in addition to floating point operations. Depending on the type of operation performed, results of the operation can be tracked by the appropriate retirement register rather than there being a strict 1:1 correspondence between computing region and retirement register.

As used herein, the term “integrated circuit,” can generally refer to a set of electronic circuits. For example, and without limitation, an integrated circuit can be configured as a chip, microchip, and/or microelectronic circuit of communicatively coupled circuit elements in one or more semiconductor wafers. In this context, example circuit elements can correspond to resistors, capacitors, diodes, transistors, etc. Example circuit elements can be one or more logic transistors, one or more analog devices, and/or one or more features sets (e.g., static random access memory, fuses, temperature sensors, etc.). Furthermore, examples of integrated circuits can include central processing units (CPUs), graphics processing units (GPUs), accelerator processing units (APUs), neural network processors (NNPs), application-specific integrated circuits (ASICs), and the like. Integrated circuits can include a variety of computing regions.

In some embodiments, an integrated circuit can use an out-of-order execution (OoOE) scheme, sometimes referred to as dynamic execution. OoOE schemes allow processors to execute instructions in a different order than what is explicitly specified by a given program, so long as the final result is not affected by performing the operations out of program order. Such an execution paradigm can more efficiently utilize processor cycles by allowing instructions that can be run immediately and independently to be processed during processor time that would otherwise be wasted. Operations that have been issued to a processer under an OoOE or dynamic execution scheme but not yet finalized (e.g., resolved in a completion buffer according to program order) are referred to as “in-flight operations”.

The term “computing region” as used herein can refer to any portion or component of an integrated circuit that is designed to perform a specific computational function. Some examples of computing regions include arithmetic logic units (ALUs), floating point units (FPUs), and the like.

The term “retirement register,” also referred to as a “retirement queue,” as used herein refers to a component of an integrated circuit designed and intended to store information that tracks outputs of computing regions (i.e., the results of speculatively executed operations) before those outputs are considered fully complete and committed to memory, i.e., “retired”. These registers help the integrated circuit output results in program order, or the order that the integrated circuit received instructions to perform calculations, by storing operations that are “in-flight”, i.e., fully calculated but not yet committed to memory. In some examples, a retirement register can hold a fixed number of entries and can allocate a specific amount of storage space to each entry. For example, a retirement register can be configured to store 64 entries of 64 bits each. Retirement registers can be situated within an integrated circuit in proximity to (e.g., adjacent to) or within their associated computing regions.

The entries stored in a retirement register can include a variety of information designed to ensure that the integrated circuit can correctly retire results of calculations and/or perform flush recovery from the memory. For example, an entry can include any relevant information related to the execution and resolution of an in-flight operation, such as mappings from logical to physical data registers, cache addresses of calculation results, operational dependencies (e.g., input operands to the in-flight operation and/or operations that depend on the result of the in-flight operation), and/or any other necessary information required to properly retire the operation. When an operation is retired, the operation is considered fully executed and the results of the operation are made visible to other components of the associated computing system as though the operation were executed in program order, i.e., the order in which instructions were sent to the integrated circuit. Once this occurs, the retirement entries associated with the operation are removed from the retirement queue. As described herein, certain retirement registers can store entries related to only a single data type. For example, some retirement registers may only include entries related to calculations performed by a floating point logic unit.

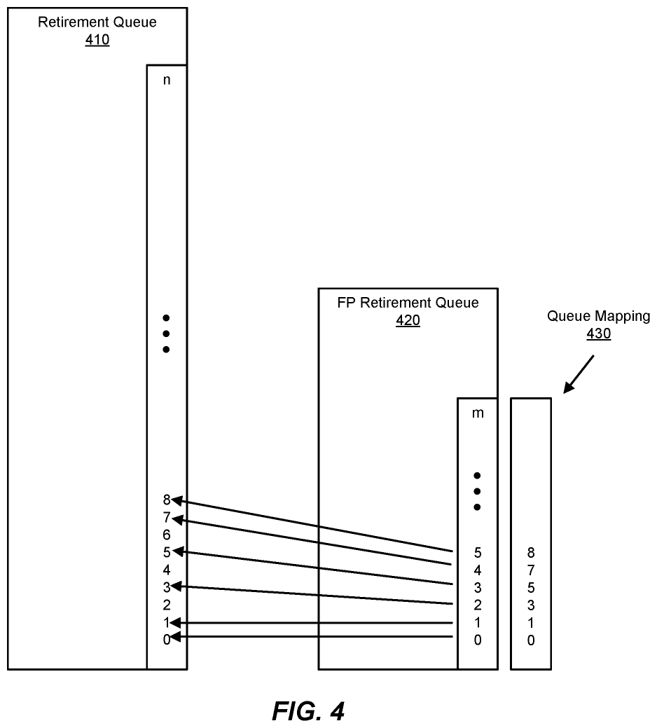

In the examples described herein, some retirement registers might only store entries related to a single type of data. For example, if computing region 140 represents a floating point logic unit, retirement register 150 might only store entries that track results of floating point operations. As will be described in greater detail below with respect to FIG. 4, the retirement register can also include queue mappings that map entries in one retirement register or retirement queue to overall retirement queue positions.

As described above, example system 100 can include one or more memory devices, such as memory 160. Memory 160 generally represents any type or form of volatile or non-volatile storage device or medium capable of storing data and/or computer-readable instructions. Examples of memory 160 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory. Additionally or alternatively, memory 160 can represent a cache or other local memory of the integrated circuit. In some examples, integrated circuit 110 can commit results of operations performed by computing regions 120 and 140 to memory 160.

In some embodiments, one retirement register can be designated as a “primary” retirement register and other retirement registers can be designated as “secondary” retirement registers. For example, and with continued reference to FIG. 1, retirement register 130 can be designated as the primary retirement register that tracks the overall status of the retirement queue and dispatches results for commitment to memory and retirement. In these examples, retirement register 150, as a secondary retirement register, can exclusively store entries related to results output by computing region 140 (such as results of floating point operations).

Secondary registers, such as the floating point retirement registers described herein, can be smaller than a full unified retirement register. This is because it is extremely unlikely that every calculation performed by an integrated circuit in a given retire cycle will be of the specific data type tracked by that register (e.g., floating point operations). Therefore, it is unnecessary to provide the same amount of data storage for the secondary register as would be required for one single unified register. Likewise, the primary register may be somewhat smaller than a single unified register given that it can simply store pointers to the entries stored in the secondary register. However, in some embodiments, the primary register might require more physical area to implement than the secondary register by virtue of coordinating retirement of entries stored in both the primary and secondary registers. Overall, it is possible that the total chip area required to implement both the primary and secondary registers will be slightly larger than in integrated circuits that rely on a single unified retirement queue. However, splitting up the retirement queues by data type can result in significant time and energy savings by increasing the electrical efficiency of retirement operations and speeding up flush recovery when calculations are retired.

Reconciliation of the results tracked by retirement register 150 with the overall or global retirement queue for integrated circuit 110 can be accomplished in a variety of ways. For example, a primary retirement register can track a global retirement queue for integrated circuit 110. As a specific example of how such a global retirement queue might be implemented, retirement register 130 can store entries that include pointers to data stored in retirement register 150, thereby minimizing the amount of data that must be stored in retirement register 130 while also ensuring that all retirement entries are properly tracked. Additionally or alternatively, retirement register 150 can include queue mappings stored in association with each entry stored in retirement register 150, with each queue mapping indicating a position in the overall queue.

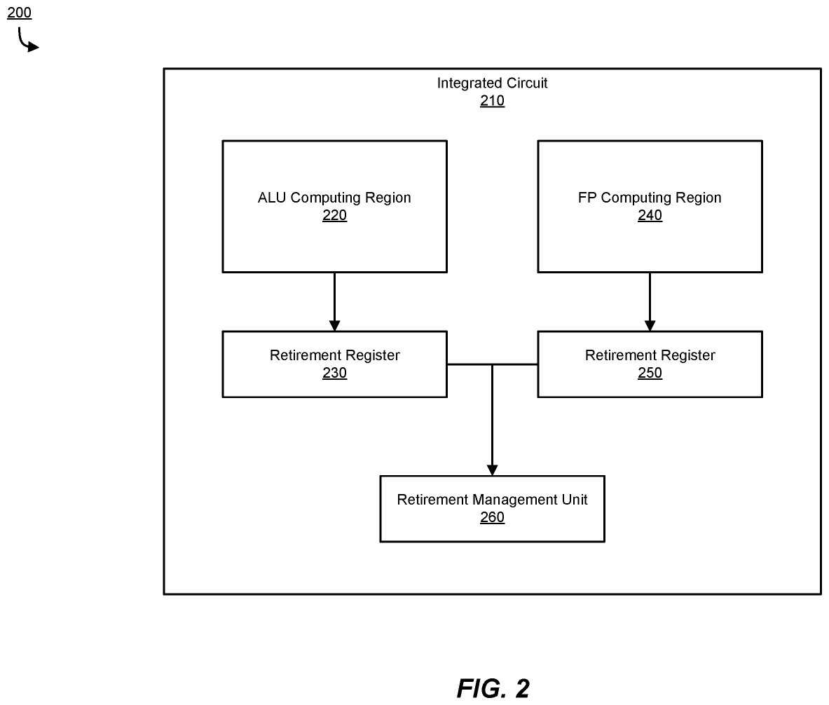

In some embodiments, an integrated circuit can include a retirement management unit that coordinates retirement of entries from all of the retirement registers present in an integrated circuit. FIG. 2 is a block diagram of example integrated circuit 210 which includes two computing regions, ALU computing region 220 and FP computing region 240. In this example, ALU computing region 220 is a general purpose arithmetic logic unit, while FP computing region 240 is a floating point logic unit. Each computing region has an associated retirement register that stores entries that track results of in-flight computations performed by the respective computing region. In this case, retirement register 230 tracks results output by ALU computing region 220, and retirement register 250 tracks results output by FP computing region 240. As described above, retirement register 250 can exclusively store entries that track results of floating point operations. Integrated circuit 210 can also include retirement management unit 260, which can maintain a token pool, pointer list, or other suitable form of tracking the overall or global retirement queue for integrated circuit 210. Retirement management unit 260 can then facilitate the commitment of calculation results to memory in program order.

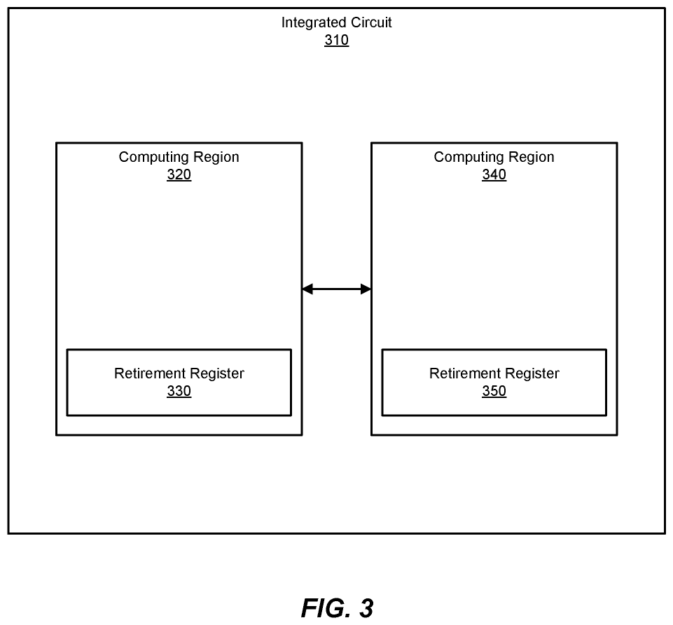

As described above, the physical structures that implement retirement registers can be disposed within an integrated circuit in a variety of ways. In some examples, retirement registers can be situated in close proximity and/or adjacent to their respective computing regions. In other examples, and as illustrated in FIG. 3, they can be situated within their respective computing regions. In the example of FIG. 3, an integrated circuit 310 includes two computing regions, computing region 320 and computing region 340. Each computing region has an associated retirement register: computing region 320 is associated with retirement register 330, and computing region 340 is associated with retirement register 350. In this embodiment, retirement register 330 is physically disposed within computing region 320 and retirement register 350 is physically disposed within computing region 340. Situating retirement registers within their respective computing regions can reduce the distance needed for electrical signals to travel between a computing region and the relevant retirement register, thereby improving the overall electrical and thermal efficiency of integrated circuit 310.

As mentioned above, retirement registers and retirement queues generally require some way of reconciling their retirement entries with the overall or global retirement queue in order to maintain operation order coherency. One such method is illustrated in FIG. 4. In this example, retirement queue 410 represents a global retirement queue responsible for tracking all retirement entries for an integrated circuit. Retirement queue 410 maintains entry slots 0 through n, denoted on the right hand side of retirement queue 410. FP retirement queue 420, on the other hand, only stores entries relating to the results of floating point operations and maintains entry slots 0 through m, where m is smaller than n. In order to facilitate reconciliation of entries stored in FP retirement queue 420 with retirement queue 410, FP retirement queue 420 also includes queue mapping 430 that indicates a position in the global retirement queue for each entry stored in FP retirement queue 420. As illustrated in FIG. 4, entry 0 in FP retirement queue 420 maps to position 0 in the global retirement queue maintained by retirement queue 410, entry 1 maps to position 1, entry 2 maps to position 3, entry 3 maps to position 5, entry 4 maps to position 7, entry 5 maps to position 8, etc. Retirement queue 410 can then reference pointers stored in retirement queue 410 to retrieve data from FP retirement queue 420 when appropriate.

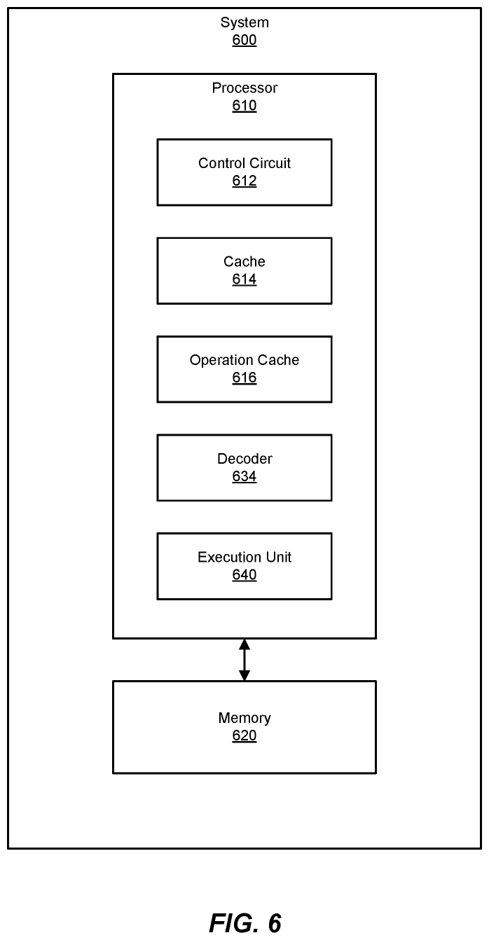

FIG. 5 is a flow diagram of an example computer-implemented method 500 for out-of-order task resolution in integrated circuits. The steps shown in FIG. 5 can be performed by any suitable computing system, including system 100 in FIG. 1, system 200 in FIG. 2, system 600 in FIG. 6, and/or variations or combinations of one or more of the same. In one example, each of the steps shown in FIG. 5 can represent an algorithm whose structure includes and/or is represented by multiple sub-steps, examples of which will be provided in greater detail below.

As illustrated in FIG. 5, at step 502 one or more of the systems described herein can store a first set of entries that include information pertaining to results of computations performed by a first computing region of an integrated circuit that performs computations according to an out-of-order execution scheme in a first retirement register. For example, a CPU can store entries for tracking results of calculations performed by an arithmetic logic unit in the first retirement register.

At step 504 of FIG. 5, the integrated circuit can store a second set of entries that include information pertaining to results of computations performed by a second computing region in a second retirement register. For example and as described in greater detail above, entries for tracking results of calculations performed by a floating point logic unit can be stored in the second retirement register.

Finally, at step 506, the integrated circuit can commit the results of the computations stored in the first and second retirement registers to memory according to the out-of-order execution scheme using the first and second set of entries. For example, the integrated circuit can use specialized retirement management logic units, pointers stored in the first register that reference entries in the second register, or other reconciliation methods to select operations for retirement, i.e., resolution, to preserve commitment in program order.

FIG. 6 is a block diagram of an example system 600 that leverages the principles described herein. System 600 corresponds to a computing device, such as a desktop computer, a laptop computer, a server, a tablet device, a mobile device, a smartphone, a wearable device, an augmented reality device, a virtual reality device, a network device, and/or other electronic device. As illustrated in FIG. 6, system 600 includes one or more memory devices, such as memory 620. Memory 620 generally represents any type or form of volatile or non-volatile storage device or medium capable of storing data and/or computer-readable instructions. Examples of memory 620 include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, and/or any other suitable storage memory.

As illustrated in FIG. 6, example system 600 also includes one or more physical processors, such as processor 610, which can correspond to one or more processors (e.g., a host processor along with a co-processor, which in some examples can be separate processors). Processor 610 generally represents any type or form of hardware-implemented processing unit capable of interpreting and/or executing computer-readable instructions. In some examples, processor 610 accesses and/or modifies data and/or instructions stored in memory 620.

Examples of processor 610 include, without limitation, one or more instances of chiplets (e.g., smaller and in some examples more specialized processing units that can coordinate as a single chip), microprocessors, microcontrollers, Central Processing Units (CPUs), graphics processing units (GPUs), Field-Programmable Gate Arrays (FPGAs) that implement softcore processors, Application-Specific Integrated Circuits (ASICs), systems on chip (SoCs), co-processors such as digital signal processors (DSPs), Neural Network Engines (NNEs), accelerators, portions of one or more of the same, variations or combinations of one or more of the same (e.g., a host processor and a co-processor), and/or any other suitable physical processor(s). Further examples of processor 610 can include integrated circuit 110 in FIG. 1, integrated circuit 210 in FIG. 2, integrated circuit 310 in FIG. 3, and/or variations or combinations of the same. In some embodiments, processor 610 can be communicatively coupled to memory 620 by, e.g., a bus or other interconnect.

In some implementations, the term “instruction” refers to computer code that can be read and executed by a processor. Examples of instructions include, without limitation, macro-instructions/macro-operations (e.g., program code that requires a processor to decode into processor instructions that the processor can directly execute) and micro-operations (e.g., low-level processor instructions that can be decoded from a macro-instruction and that form parts of the macro-instruction). In some implementations, micro-operations correspond to the most basic operations achievable by a processor and therefore can further be organized into micro-instructions (e.g., a set of micro-operations executed simultaneously).

As further illustrated in FIG. 6, processor 610 includes a control circuit 612, a cache 614, an operation cache 616, as well as various other functional units such as a decoder 634, and an execution unit 640. Control circuit 612 corresponds to circuitry and/or instructions for dividing load operations (e.g., instructions for loading values from memory/cache into registers, which can correspond to macro-instructions and/or micro-operations), as will be described further below. In some examples, control circuit 612 can also combine load operations, which can subsequently be divided (e.g., a reverse of the load operation division described herein). Though not illustrated in FIG. 6, processor 610 can also include specific processing regions and/or retirement registers as described in greater detail above.

Cache 614 corresponds to a local storage used by processor 110 (e.g., a client-side cache such as a low-level cache or L1 cache) for holding data/instructions from a memory device such as memory 620. In some examples, cache 614 corresponds to and/or includes other caches, such as a memory-side cache. Further, cache 614 can correspond to a cache hierarchy, having multiple levels of caches that in some implementations can have different properties (e.g., lower-level caches such as L1 being smaller yet faster compared to higher-level caches such as L2 and above being progressively larger yet slower).

Operation cache 616 corresponds to a storage for holding decoded instructions. Decoder 634 corresponds to a circuit for decoding instructions. Execution unit 640 corresponds to a logic or arithmetic unit which can perform decoded instructions. In some examples, execution unit 640 (and corresponding instructions) can correspond to a scalar unit for operating on single data elements (as operands), or a vector unit for operating on arrays of data element (as operands, which in some implementations further includes circuitry and/or instructions for vector operations). In some implementations, control circuit 612 can include or otherwise interface with decoder 634.

In some examples, processor 610 (and/or a functional unit thereof) reads program instructions (e.g., macro-operations) from memory 620 and decodes (e.g., by decoder 634) the read program instructions into micro-operations, which in some examples can include finding a corresponding decoded entry (e.g., a sequence of micro-operations) in operation cache 616. In some implementations, processor 610 (and/or a functional unit thereof) can send the newly decoded micro-operations to an appropriate execution unit of processor 610 (e.g., execution unit 640) when available to execute micro-operations as part of an instruction pipeline (a sequences of stages for a processor to perform instructions).

As described in greater detail above, including one or more additional data-type specific retirement registers can enable integrated circuits that use out-of-order execution schemes to perform retirement operations and flush recovery with greater electrical and thermal efficiency than integrated circuits that rely on only a single retirement register. Furthermore, including more than one retirement register can speed up flush recovery of the retirement system as a whole by virtue of being able to perform more actions in a given cycle.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. An integrated circuit comprising:
a first computing region and a second computing region, wherein the integrated circuit performs computations according to an out-of-order execution scheduling scheme;
a first retirement register that stores a first set of entries comprising information pertaining to results of computations performed by the first computing region; and
a second retirement register, physically disposed in proximity to the second computing region, that stores a second set of entries comprising information pertaining to results of computations performed by the second computing region.

2. The integrated circuit of claim 1, wherein:
the second computing region comprises a floating point unit; and
wherein the second set of entries comprises information pertaining to results of computations performed by the floating point unit.

3. The integrated circuit of claim 1, wherein the second retirement register stores each entry in the second set of entries in association with a retirement identifier that maps the entry to a position in a global retirement queue, the global retirement queue specifying a retirement order for results of computations performed by both the first and second computing regions.

4. The integrated circuit of claim 1, wherein the first set of entries comprises information necessary to properly retire calculations performed by the first computing region and the second computing region.

5. The integrated circuit of claim 4, wherein the first set of entries stored in the first retirement register comprises pointers to information stored in the second retirement register.

6. The integrated circuit of claim 1, wherein the second set of entries pertain to results of a single data type.

7. The integrated circuit of claim 6, wherein the single type is the result of floating point operations.

8. The integrated circuit of claim 1, wherein the second retirement register is physically disposed within the second computing region.

9. The integrated circuit of claim 1, further comprising a retirement logic management component that ensures results of computations performed by the first computing region and the second computing region are processed according to the out-of-order execution scheduling scheme.

10. The integrated circuit of claim 1, wherein the integrated circuit comprises a central processing unit (CPU).

11. A system comprising:
a physical memory;
an integrated circuit, communicatively coupled to the memory, comprising:
a first computing region and a second computing region, wherein the integrated circuit performs computations according to an out-of-order execution scheduling scheme;
a first retirement register that stores a first set of entries comprising information pertaining to results of computations performed by the first computing region; and
a second retirement register, physically disposed in proximity to the second computing region, that stores a second set of entries comprising information pertaining to results of computations performed by the second computing region; and
a physical memory that stores an output of the integrated circuit.

12. The system of claim 11, wherein:
the second computing region comprises a floating point unit; and
wherein the second set of entries comprises information pertaining to results of computations performed by the floating point unit.

13. The system of claim 11, wherein the second retirement register stores each entry in the second set of entries in association with a retirement identifier that maps the entry to a position in a global retirement queue, the global retirement queue specifying a retirement order for results of computations performed by both the first and second computing regions.

14. The system of claim 11, wherein the first set of entries stored in the first retirement register comprises information necessary to properly retire calculations performed by the first computing region and the second computing region.

15. The system of claim 14, wherein the first set of entries stored in the first retirement register comprises pointers to results stored in the second retirement register.

16. The system of claim 11, wherein the second set of entries pertain to results of a single data type.

17. The system of claim 16, wherein the single type is results of floating point operations.

18. The system of claim 11, wherein the second retirement register is physically disposed within the second computing region.

19. The system of claim 11, wherein the integrated circuit further comprises a retirement logic management component that ensures results of computations performed by the first computing region and the second computing region are processed according to the out-of-order execution scheduling scheme.

20. A method comprising:
storing a first set of entries comprising information pertaining to results of computations performed by a first computing region of an integrated circuit in a first retirement register, wherein the integrated circuit performs computations according to an out-of-order execution scheduling scheme;
storing a second set of entries comprising information pertaining to results of computations performed by a second computing region of the integrated circuit in a second retirement register that is physically disposed in proximity to the second computing region; and
committing, based on the first set of entries and the second set of entries, results of the computations performed by the first and second computing regions from the first and second retirement registers according to the out-of-order execution scheduling scheme.
